(19) United States
(12) Patent Application Publication
(10) Pub. No.: US 2008/0226288 A1
(43) Pub. Date: Sep. 18, 2008

(54) METHOD AND APPARATUS FOR PERFORMING RECEIVER SENSITIVITY TESTING AND STRESSED RECEIVE SENSITIVITY TESTING IN A TRANSCEIVER

(76) Inventor: Frederick W. MILLER, Santa Clara, CA (US)

Correspondence Address: Kathy Manke;Avago Technologies Limited, 4380 Ziegler Road, Fort Collins, CO, 80525, US

(21) Appl. No.: 11/686,161

(22) Filed: Mar. 14, 2007

(51) Int. Cl. H04B 17/00

(52) U.S. Cl. 398/9

(57) ABSTRACT

An apparatus and method are provided for use in a transceiver that enable the transceiver to test itself to determine whether the receiver portion of the transceiver meets receiver sensitivity requirements and stressed receive sensitivity requirements.

### TECHNICAL FIELD OF THE INVENTION

The invention relates to transceivers used to transmit and receive data in the form of optical signals over optical waveguides. More particularly, the invention relates to a method and an apparatus for use in a transceiver to allow the transceiver to self-test receiver sensitivity and stressed receive sensitivity.

### BACKGROUND OF THE INVENTION

In optical communications networks, transceivers are used to transmit and receive optical signals over optical fibers. On the transmit side of the transceiver, a laser of the transceiver generates amplitude modulated optical signals that represent data, which are then transmitted over an optical fiber coupled to a receiver. The received optical signals are converted into electrical signals by a photodiode and amplified to recover the data.

Prior to a transceiver being shipped to a customer, various tests are performed to ensure that the transceiver operates properly. Two such tests are the receiver sensitivity test and the stressed receive sensitivity test. The receiver sensitivity test is performed by varying the optical power level of the signal being received over the fiber at the receive side of the transceiver and measuring the bit error rate (BER) as a function of the optical power level of the signal. If the measured/extrapolated minimum receive power at the targeted BER remains at an acceptable level, the test passes; otherwise, the test fails. The stressed receive sensitivity test is performed by sending a degraded signal over the fiber while also varying the optical power level of the signal and measuring the BER at the receive side of the transceiver. The signal is degraded in different ways, such as by adding different types of jitter to the signal, adding interference to the signal, varying the extinction ratio of the signal, varying the degree of eye closure, varying rise and fall times, etc. If the measured/extrapolated minimum receive power at the targeted BER remains at an accepted level during the test, the test passes; otherwise, the test fails.

FIG. 1 illustrates a block diagram of a transceiver 2 connected to test equipment 3 for performing the receiver sensitivity test and stressed receive sensitivity test. The test equipment 3 includes a pattern generator that generates a test bit pattern that is used to modulate a laser to produce an optical test signal. The optical test signal is output from the test equipment 3 and sent over an optical fiber 4, which is connected on one end to the test equipment and on the other end to an optical attenuator 5. The optical attenuator 5 attenuates the optical test signal by a selected amount and outputs the attenuated optical signal over an optical fiber 6, which is connected on one end to the optical attenuator 5 and on the other end to the receive side of the transceiver 2. The receive side of the transceiver 2 recovers the attenuated optical test signal, which is then output via an electrical cable 7 to the test equipment 3. The test equipment 3 compares the signal with the bit pattern that was used to create the test optical signal in order to compute the BER. A power monitor 8 is used to allow a user to monitor the optical power level of the optical test signal.

The test equipment 3 is capable of degrading the test optical signal by adding various types of jitter and interference to the test optical signal, varying the extinction ratio of the test signal, varying the rise and fall times of the test signal, varying the closure of the eye, etc. Based on the BER, the test equipment 3 determines whether or not the receiver portion of the transceiver 2 has passed or failed the receiver sensitivity test and the stressed receive sensitivity test.

One of the disadvantages of performing testing using a configuration such as that shown in FIG. 1 is that it is relatively difficult to setup and requires expensive test equipment. A device under test (DUT) board must be created, the transceiver must be connected to the board, and the board must be connected to the test equipment. Because of the difficulties and time associated with setting up the tests, each part cannot be individually tested. Rather, prior to shipping the transceivers to customers, a selected number of the transceivers from each batch are subjected to a variety of tests, including the receiver sensitivity test and stressed receive sensitivity test. If the selected transceivers of a given batch pass the tests, all of the transceivers of the batch are deemed to be acceptable for shipment to customers. Of course, it is possible, although unlikely, that one or more of the untested transceivers are faulty and would not have passed the tests, and thus there is a margin of error inherent in this approach.

It would desirable to provide an apparatus and method for performing the types of tests and measurements described above that do not require performance of the extensive setup procedure described above with reference to FIG. 1. It would also be desirable to provide such a method and apparatus that would also enable all of the transceivers of each batch to be tested, as opposed to only selected transceivers from each batch being tested.

### SUMMARY OF THE INVENTION

An apparatus and method are provided for use in a transceiver for measuring the sensitivity of a receiver portion of the transceiver. The apparatus comprises sensitivity self-test circuitry configured to enable the transceiver to test itself for sensitivity. The method comprises performing a sensitivity self-test in a transceiver to measure the sensitivity of the receiver portion of the transceiver.

These and other features and advantages of the invention will become apparent from the following description, drawings and claims.

### BRIEF DESCRIPTION OF THE DRAWINGS

FIG. 1 illustrates a block diagram of a known transceiver connected to known test equipment for performing receiver sensitivity and stressed receive sensitivity testing.

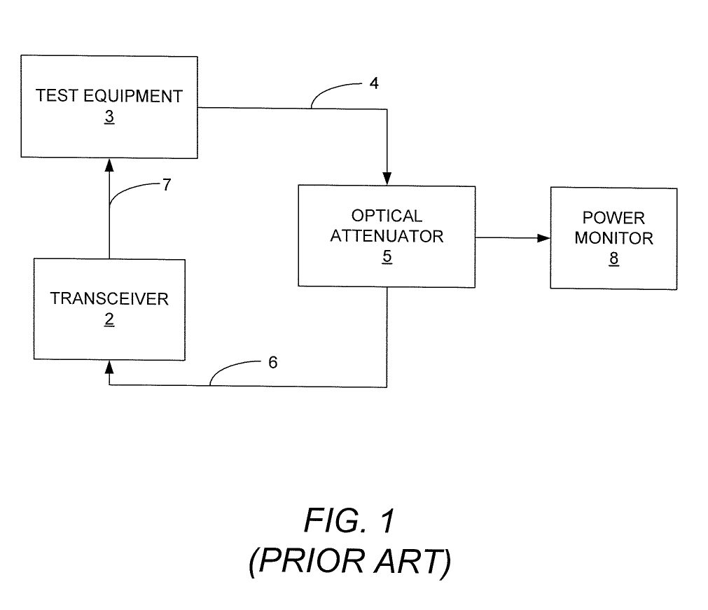

FIG. 2 illustrates a block diagram of the transceiver in accordance with an embodiment having test circuitry that enables the transceiver to self-test receiver sensitivity and stressed receive sensitivity.

FIG. 3 illustrates a flowchart that represents the method in accordance with an embodiment for performing receiver sensitivity testing in a transceiver.

FIG. 4 illustrates a flowchart that represents the method in accordance with an embodiment for performing stressed receive sensitivity testing in a transceiver.

### DETAILED DESCRIPTION OF AN ILLUSTRATIVE EMBODIMENT

In accordance with one embodiment, the apparatus is a transceiver that includes test circuitry that enables the transceiver to test itself to determine whether the receiver portion of the transceiver meets receiver sensitivity requirements and stressed receive sensitivity requirements. Thus, each and every transceiver is capable of being tested in a relatively short period of time without having to use expensive test equipment and without having to perform an extensive setup procedure in order to test the transceivers.

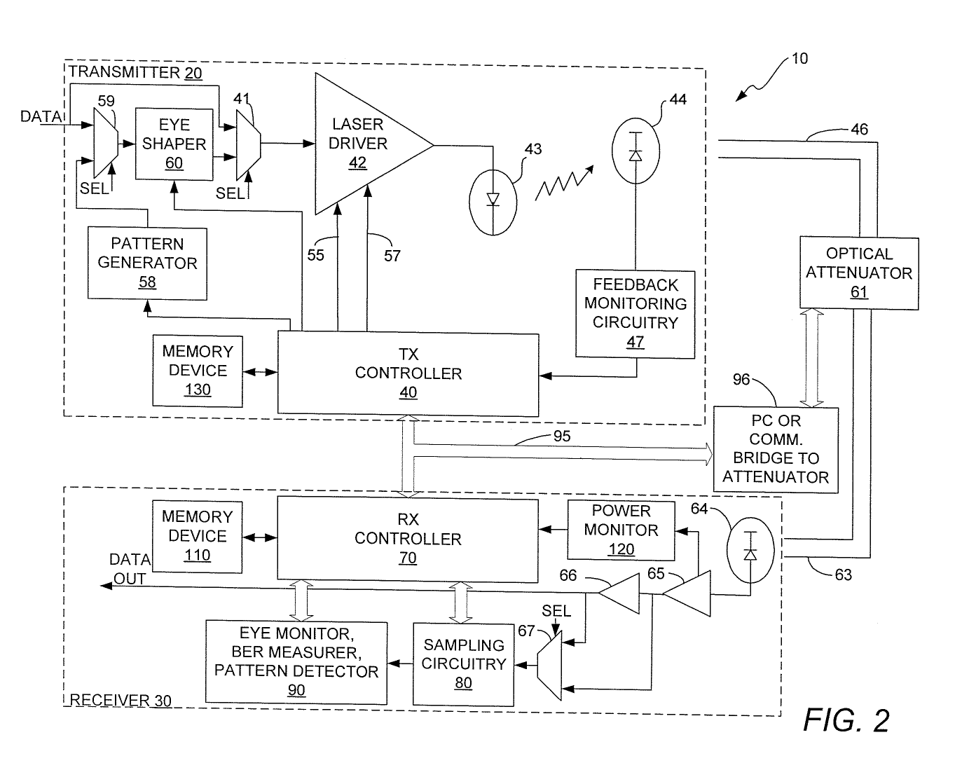

FIG. 2 illustrates a block diagram of the transceiver 10 in accordance with an embodiment having test circuitry that enables the transceiver to self-test receiver sensitivity and stressed receive sensitivity. The transceiver 10 has a transmitter portion 20 and a receiver portion 30. The transmitter and receiver portions 20 and 30 include self-test circuitry for measuring and evaluating receiver sensitivity and stressed receive sensitivity. The operations of the transmitter portion 20 are controlled by the TX controller 40. During the normal mode of operations, the TX controller 40 asserts the select signal to the multiplexer (MUX) 41, which causes the MUX 41 to provide the actual data stream, DATA, to the input of the laser driver 42. The TX controller 40 outputs control signals 55 and 57 to the laser driver 42, which the laser driver 42 uses to set the amplitudes of the bias current and modulation current of the laser 43.

Most of the light generated by the laser 43 is directed into an end of an optical fiber 46, while some of the light is directed toward a monitor photodiode 44. The monitor photodiode 44 produces an electrical feedback signal in response to receiving the laser light and outputs the electrical feedback signal to feedback monitoring circuitry 47. The feedback monitoring circuitry 47 detects the optical modulation amplitude (OMA) and/or average power of the feedback signal and provides an OMA and/or average power value to the TX controller 40. The TX controller 40 processes the measured power level values and outputs the appropriate bias current and modulation current control signals 55 and 56 to the laser driver 42, which the laser driver 42 uses to adjust the amplitudes of the laser bias and modulation currents, respectively.

During the test mode of operations, the select line to the MUX 41 is de-asserted, which causes the output of an eye shaper 60 to be provided as the input to the laser driver 42. The select line to MUX 59 is asserted so that the input to the eye shaper 60 is a bit pattern generated by the bit pattern generator 58. The bit pattern is typically a pseudo random bit sequence (PRBS) comprising a sequence of binary 1s and 0s. The bit pattern may instead by some other non-random designated stressful bit pattern. The purpose of the eye shaper 60 is to stress the signal that will be used to drive the laser 43 in order to perform the stressed receive sensitivity test. The eye shaper 60 comprises eye shaping circuitry that is configured to inject deterministic jitter and/or random jitter into the signal input to the eye shaper 60, and/or adjust the slew rate of the signal and/or to add amplitude noise to the signal in order to close the eye as needed to stress the signal. The TX controller 40 sends control signals to the eye shaper 60 to control the shape of the stressed waveform.

The self-tests may be performed during production prior to the transceivers being shipped to customers and/or in situ after the transceivers have been shipped to customers and inserted into the network. The settings that are needed by the eye shaper 60 to provide the waveform with the desired eye mask profiles preferably are stored in non-volatile memory device 130 to allow in situ link margin testing to be performed in the field. The process of calibrating the eye shaper circuitry to determine which settings to store in memory is accomplished using the eye monitor 90 and other measurement circuits in the receiver portion 30 of the transceiver 10 during loop back testing, preferably during the manufacturing phase. The eye shaper 60 programming settings that are determined during this calibration process can be recalled from memory at later times to produce the desired signal shaping at the output of the transmitter portion 20. For this type of testing in the field, the select line to MUX 59 is de-asserted so that the input to the eye shaper 60 is the actual data stream. The select line to the MUX 41 is also de-asserted so that the output of the eye shaper 60 is provided to the laser driver 42 and used to modulate the laser 43. By passing the actual data through the wave shaping circuitry of the eye shaper 60, a desired level of link level degradation can be added to the data signal to enable the testing of the link for margin and failures.

During the test mode, the light generated by the laser 43 that is directed into the end of the fiber 46 propagates down the fiber 46 to an optical attenuator 61. The optical attenuator 61 attenuates the signal in the typical manner as is known in the industry to perform sensitivity testing. The attenuated signal output from the optical attenuator 61 on fiber 63 propagates down the fiber 63 and is directed onto the receive photodiode 64 of the receiver portion 70 of the transceiver 10. The receive photodiode 64 converts the received light into an electrical signal. The amplitude of the electrical signal is measured and amplified by a transimpedance amplifier (TIA) 65, which is a high-speed amplifier typically used to convert the current from the photodiode to a voltage signal. The output of the TIA 65 is received by a limiting amplifier (LA) 66 and by a MUX 67. The LA 66 limits the amplitude of the signal received from the TIA 65 so that it is suitable for processing by downstream circuitry (not shown). The limited signal is provided as an input to the MUX 67. Whichever input is selected by the MUX 67 is provided as input to sampling circuitry 80, as will be described below in detail.

The operations of the receiver portion 30 are controlled by the RX controller 70. During a test calibration mode of operations, the select signal to MUX 67 is asserted by the RX controller 70 so that the output of the TIA 65 is provided as input to the sampling circuitry 80. Subsequently, during the test mode of operations, the select signal to MUX 67 is de-asserted so that the output of the LA 66 is provided as input to the sampling circuitry 80. In both modes, the sampling circuitry 80 and eye monitor 90 are used to sample selected areas within an eye mask to see if it meets the desired criteria. The data can also be sent to a computer terminal (not shown) of the module to generate an eye diagram to be displayed on a visual monitor (not shown) to enable characteristics of signal quality to be evaluated (e.g., BER, mask margin, jitter, rise and fall times, logic 1 level, logic 0 level, crossing level of rise and fall times, double tracing anomalies, hits in the eye region, etc.). During the calibration mode, the RX controller 70 evaluates data from the eye monitor 90 to determine whether the desired eye mask profile has been achieved. The TX controller 40 varies the circuit configuration of the eye shaper 60 based on feedback from the RX controller 70 until the desired eye mask profile is measured by the eye monitor 90.

When sensitivity testing is performed subsequent to calibration being successfully performed, the controller 70 de-asserts the select line to MUX 67 so that the output of the LA 66 is provided to the sampling circuitry 80. The reason for providing the output of the TIA 65 to the sampling circuitry 80 during calibration is that the output of the TIA 65 needs to be looked at before quantization by the LA 66. Otherwise, linear amplitude information in the eye mask might be lost. After calibration has been performed, the signal output from the LA 66 is measured and evaluated.

The sampling circuitry 80 repetitively samples the signal it receives. As the sampling circuitry 80 samples the input signal, the samples are digitized and stored in memory device 110 by the RX controller 70. The samples are taken at various points in the signal by adjusting sampling threshold and phase. This generates signal integrity data that the RX controller 70 uses to assess signal quality. The measured data can also be transferred out of the module to a workstation (not shown) where it can be visually displayed for an operator to asses the signal quality (e.g., BER, mask margin, jitter, rise and fall times, logic 1 level, logic 0 level, crossing level of rise and fall times, double tracing anomalies, hits in the eye region, etc.). The sampling circuitry 80 and eye monitor 90 may be similar or identical to the sampling circuitry and the eye monitor commonly used in known test equipment, such as in existing optical time domain reflectometry (OTDR) systems. The digitized samples stored in the memory device 110 may also be read out by the RX controller 70 and provided to a host computer (not shown) to allow the host computer to perform diagnostics. In that case, the sampling circuitry 80 will typically by on-chip within the transceiver 10, but the circuitry for performing the eye monitor functionality will typically be implemented in software in the host computer (e.g., a personal computer (PC)).

A power monitor 120 of the receiver portion 30 of the transceiver 10 is used to allow a user to observe the power level of the received signal as the optical attenuator 61 is adjusted during sensitivity testing. The power levels measured by the power monitor 120 are input to the RX controller 70, which processes the power level information along with BER information to evaluate sensitivity. When performing receiver sensitivity testing with an unstressed signal, the TX controller 40 causes the eye shaper 60 to be configured such that the bit sequence output by the pattern generator 58 is not stressed, or so that a particular unstressed waveform is provided to the laser driver 42 via MUX 41. The laser driver 42 modulates the laser 43 in accordance with this waveform, causing the corresponding optical signal to be transmitted down the fiber 46 to the optical attenuator 61. The optical attenuator 61 attenuates the signal by a selected amount based on its settings and outputs the attenuated signal onto optical fiber 63. The optical signal is received by the receive photodiode 64, which converts the optical energy into an electrical signal. This electrical signal is measured by the TIA 65 and limited by the LA 66.

Assuming that calibration has already been successfully performed, the signal output from the LA 66 is selected by the MUX 67 and provided to the sampling circuitry 80, which samples the signal in the manner described above to generate the eye diagram or other signal integrity measurements. The eye monitor 90 processes and avaluates the data generated by the sampling circuitry 80 and performs BER measurements and pattern detection. Based on the power levels measured by the power meter 120 and the BER measurements obtained by the BER measurement and pattern detection circuitry of the eye monitor 90, the RX controller 70 evaluates receiver sensitivity.

The RX controller 70 is in communication with the TX controller 40 via a communications channel 95 to enable them to cooperate with each other to perform the tests. Sensitivity and stressed sensitivity are measured by the TX and RX controllers 40 and 70 by making a sequence of BER measurements while gradually decreasing the optical power of the signal being received by the receiver portion 30 by adjusting the optical attenuator 61. After a sequence of BER measurements are made at multiple power levels, the sensitivity is calculated by extrapolating the measured data down to the appropriate BER. The TX and RX controllers 40 and 70 preferably are in communication with a PC or communication bridge 96 that is used to control the level of attenuation provided by the optical attenuator 61. The PC or communication bridge 96 is optional.

The term “test circuitry”, as that term is used herein, is intended to denote some or all of the components of the transceiver 10 that play a part in performing sensitivity testing, such as, for example, the pattern generator 58, the eye shaper 60, the controllers 40 and/or 70, the sampling circuitry 80, the eye monitor 90, and the power monitor 120. It should be noted that test circuitry may take on a variety of forms other than that shown in FIG. 2. The components of the test circuitry may also take on a variety of forms. For example, it is possible to obtain a wider range of wave shaping in the eye shaper 60 by using a finite impulse response (FIR) filter (not shown) in the eye shaper 60 with suitable width and resolution and programmable tap weights. For production testing or basic in situ link margin testing, it usually is not necessary to provide this level of accuracy in the wave shaping circuitry of the eye shaper 60.

The calibration process during which the output of the TIA 65 is used to generate the eye diagram is performed through cooperation between the TX and RX controllers 40 and 70. Although the TX and RX controllers 40 and 70 are shown in FIG. 2 as being separate entities, they will typically be combined in a single IC. The TX and RX controllers 40 and 70 may be implemented as one or more state machines, or as a more flexible option, with a microcontroller sub system that runs on updatable firmware or software. In addition, although the block diagram shown in FIG. 2 depicts components separated out in two main groups comprising a transmitter portion 20 and a receiver portion 30, typically as many of these components as possible, if not all of them, will integrated into a single IC along with the TX and RX controllers. The same functionality could be obtained by using multiple components in multiple ICs, but the most cost effective and highest performing solution from a signal integrity standpoint may be a fully integrated solution.

While the apparatus has been described above as being implemented in a transceiver, the apparatus could effectively be implemented as separate transmitter and receiver devices, provided that an external communication bus that is compatible with both devices is used. In addition, while the embodiment described above with reference to FIG. 2 uses an external optical attenuator 61, in a fully integrated photonic IC, the optical attenuator may be integrated with the other circuits in the transceiver. In this case, there is no need for any external equipment, and thus the entire apparatus 10 and the optical attenuator 61 may be implemented on single IC. Also, although the apparatus 10 is intended primarily for making sensitivity measurements in a production test due to the requirement of an external optical attenuator to measure the sensitivity, if this optical attenuator is integrated on chip (i.e., with the TX and RX controllers and other circuitry) then the measurements can be made in situ while the module is deployed in a communications system. In addition, the same circuits that are used for taking the sensitivity measurements can also be used while deployed in a communications network to make a variety of other measurements, such as, for example, measurements of BER, mask margin, jitter, rise and fall times, logic 1 level, logic 0 level, crossing level of rise and fall times, double tracing anomalies, hits in the eye region, etc.

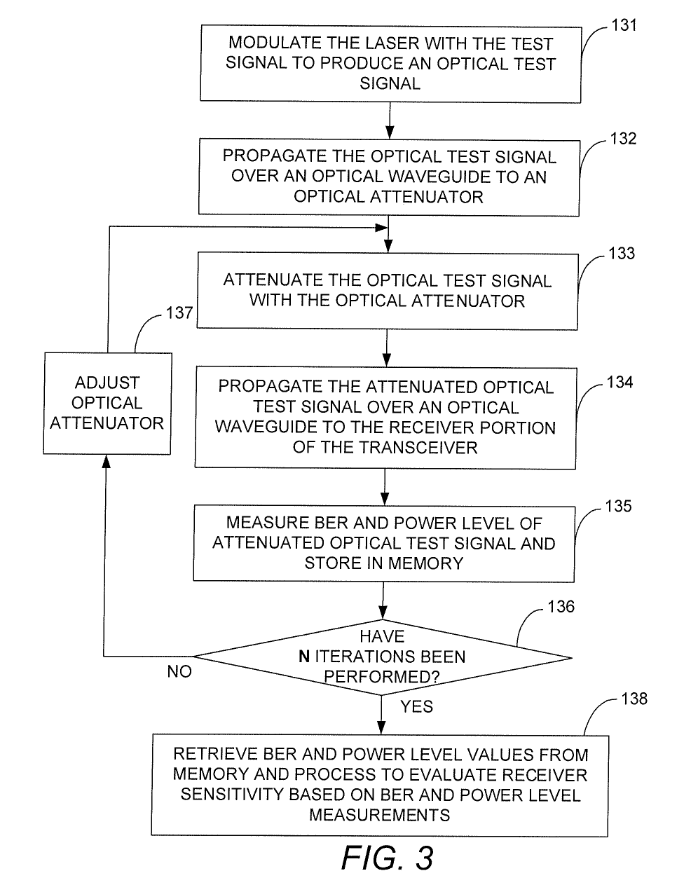

FIG. 3 illustrates a flowchart that represents the method in accordance with an embodiment for performing receiver sensitivity testing in a transceiver. In the transmitter portion of the transceiver, a laser is modulated using a test signal to produce an optical signal, as indicated by block 131. As stated above, the test signal that is used to modulate the laser may be an actual data signal being used as a test signal or it may be an actual test signal corresponding to a bit pattern produced by a pattern generator. The optical signal is propagated over an optical waveguide (e.g., an optical fiber) to an optical attenuator, which may be part of the transceiver or external to the transceiver. This step is represented by block 132. The signal is attenuated by a predetermined amount, as indicated by block 133. The attenuated signal is then propagated over an optical waveguide (e.g., an optical fiber) to the receiver portion of the transceiver, as indicated by block 134.

In the receiver portion of the transceiver, the attenuated signal is received and the BER and power level of the attenuated signal are measured and stored in memory, as indicated by block 135. The process is typically performed multiple times in order to generate a sufficient amount of data from which to extrapolate the BER. The decision block 136 represents the decision of determining whether the process has been performed a sufficient number of times (e.g., N times, where N is a positive integer). If not, the optical attenuator is then adjusted, as indicated by block 137, and the process represented by blocks 131-136 is performed again. After the process has been performed a sufficient number of times, the BER and power level measurements stored in memory are retrieved and processed by processing circuitry of the transceiver (e.g., the TX and/or RX controllers) to evaluate the receiver sensitivity, as indicated by block 138.

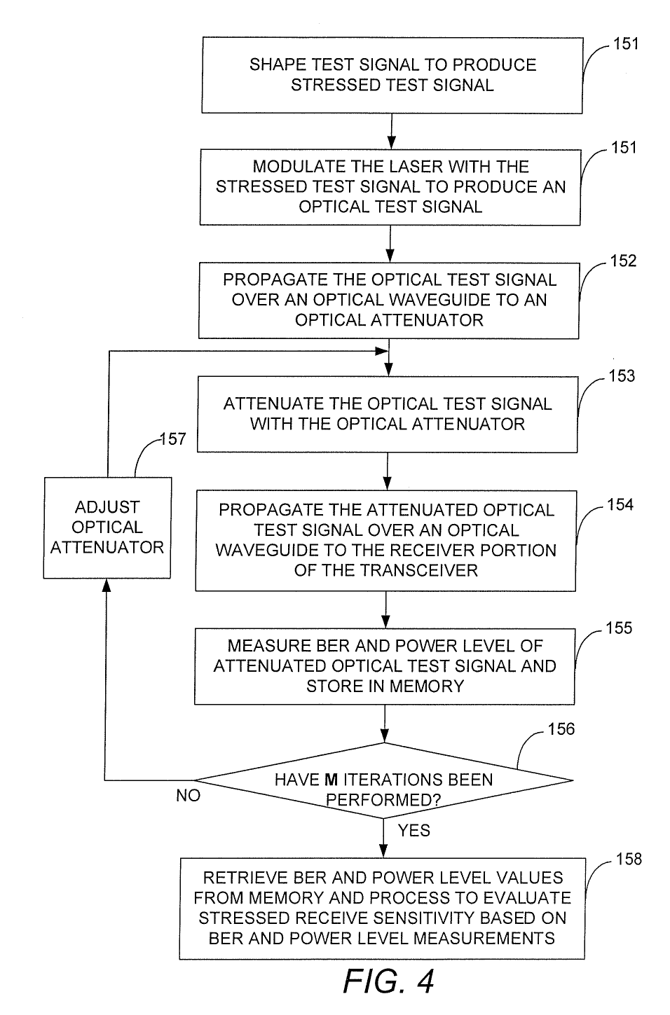

FIG. 4 illustrates a flowchart that represents the method in accordance with an embodiment for performing stressed receive sensitivity testing in a transceiver. In the transmitter portion of the transceiver, either an actual data signal or a test signal produced by a bit pattern generator is shaped to produce a stressed signal, as indicated by block 151. The stressed signal is then used in the transmitter portion to modulate a laser to produce an optical signal, as indicated by block 152. The optical signal is propagated over an optical waveguide (e.g., an optical fiber) to an optical attenuator, which may be part of the transceiver or external to the transceiver. This step is represented by block 153. The optical signal is then attenuated by the optical attenuator by a predetermined amount, as indicated by block 154. The attenuated optical signal is then propagated over an optical waveguide (e.g., an optical fiber) to the receiver portion of the transceiver, as indicated by block 155.

In the receiver portion of the transceiver, the attenuated signal is received and the BER and power level are measured and stored in memory, as indicated by block 156. A determination is then made as to whether the process represented by blocks 151-156 has been performed a sufficient number of times (e.g., M times, where M is a positive integer that may or may not be equal to N), as indicated by block 157. If not, the optical attenuator is adjusted, as indicated by block 158, and the process represented by blocks 151-156 is performed again. After a determination is made at block 157 that the process has been performed M times, the BER and power level measurements are retrieved from memory and processed by processing circuitry of the transceiver (e.g., the TX and/or RX controllers) to evaluate the stressed receive sensitivity, as indicated by block 159.

It should be noted that the apparatuses and methods have been described with reference to a few illustrative embodiments for the purposes of demonstrating the principles and concepts of the invention and to provide a few examples of the manner in which they may be implemented. The methods and apparatuses are not limited to these embodiments, as will be understood by persons skilled in the art in view of the description provided herein. The methods and apparatuses also are not limited to being used in a transceiver, but may be used in any type of device for any suitable purpose. Those skilled in the art will understand that modifications may be made to the embodiments described herein and that all such modifications are within the scope of the invention.

What is claimed is:

1. An apparatus for use in a transceiver for measuring sensitivity of a receiver portion of the transceiver, the apparatus comprising sensitivity self-test circuitry configured to enable the transceiver to test itself for sensitivity.

2. The apparatus of claim 1, wherein the apparatus further comprises:
a laser capable of being modulated to produce light;
a laser driver configured to modulate the laser with an electrical test signal to cause the laser to produce an optical test signal that is launched into a first end of a first optical waveguide, the first end of the first optical waveguide being optically coupled to the transceiver, the second end of the second optical waveguide being optically coupled to an input port of an optical attenuator;
an optical signal detector that receives an attenuated form of the optical test signal after the optical test signal has been attenuated by the optical attenuator, the attenuated optical signal being received by the optical signal detector from a first end of a second optical waveguide optically coupled to the transceiver, the second end of the second optical waveguide being optically coupled to an output port of the optical attenuator, the detector producing an electrical signal based on the received optical signal; and
wherein the sensitivity self-test circuitry comprises bit error rate (BER) measurement circuitry, power level measurement circuitry, and sensitivity evaluation circuitry, the BER measurement circuitry being configured to measure the BER and the power level of the attenuated optical test signal, the power level measuring circuitry being configured to measure the power level of the attenuated optical test signal, and wherein the sensitivity evaluation circuitry is configured to process the BER and power level measurements to evaluate one or both of receiver sensitivity and stressed receive sensitivity.

3. The apparatus of claim 2, wherein the sensitivity self-test circuitry further comprises:
sampling circuitry configured to sample the electrical signal produced by the optical signal detector to obtain sample data; and
eye monitor circuitry configured to process the sample data to measure one or more signal quality characteristics associated with the electrical signal produced by the optical signal detector.

4. The apparatus of claim 2, wherein the sensitivity self-test circuitry further comprises:
sampling circuitry configured to sample the electrical signal produced by the optical signal detector to obtain sample data, the sample data being delivered to a host computer external to the transceiver, the host computer comprising eye monitor circuitry configured to process the sample data to measure one or more signal quality characteristics associated with the electrical signal produced by the optical signal detector.

5. The apparatus of claim 2, wherein the sensitivity self-test circuitry further comprises:
an eye shaper having waveform shaping circuitry configured to stress an input signal to produce a stressed output signal, the stressed output signal corresponding to the electrical test signal with which the laser driver modulates the laser to produce the optical test signal.

6. The apparatus of claim 5, wherein the sensitivity self-test circuitry further comprises:
a bit pattern generator configured to generate bit patterns, and wherein the input signal to the eye shaper corresponds to a bit pattern generated by the bit pattern generator.

7. The apparatus of claim 6, wherein the bit pattern is pseudo-random bit sequence (PRBS).

8. The apparatus of claim 6, wherein the bit pattern is pre-designated bit sequence.

9. The apparatus of claim 5, wherein the input signal to the eye shaper corresponds to an actual data signal.

10. The apparatus of claim 2, wherein the optical attenuator is within the transceiver and is part of the sensitivity self-test circuitry, and wherein the first and second optical waveguides are internal to the transceiver.

11. The apparatus of claim 2, wherein the optical attenuator is external to the transceiver, and wherein the first and second optical waveguides are optical fibers that are external to the transceiver, each optical fiber having an end that is optically coupled to the transceiver.

12. The apparatus of claim 1, wherein the sensitivity self-test circuitry can be used to test the transceiver during a production phase prior to shipment of the transceiver to a customer.

13. The apparatus of claim 1, wherein the sensitivity self-test circuitry can be used to test the transceiver in situ while the transceiver is operationally connected to a network.

14. A method for measuring sensitivity of a receiver portion of a transceiver, the method comprising:
in a transceiver, using sensitivity self-test circuitry of the transceiver to perform a sensitivity self-test to evaluate a sensitivity of a receiver portion of the transceiver.

15. The method of claim 14, wherein performing the sensitivity self-test comprises:
in the transceiver, modulating a laser of a transceiver with an electrical test signal to produce an optical test signal;
propagating the optical test signal over an optical waveguide to an optical attenuator;
in the optical attenuator, attenuating the optical signal;
propagating the attenuated optical test signal over an optical waveguide to a receiver portion;
in the receiver portion of the transceiver, receiving the attenuated optical test signal and converting the attenuated optical test signal into a received electrical test signal;
measuring a bit error rate (BER) and a power level of the received electrical test signal to obtain BER and power level measurement values; and
in the transceiver, processing the BER and power level measurement values to evaluate a sensitivity of a receiver portion of the transceiver.

16. The method of claim 15, further comprising:
repeating the method multiple times to obtain multiple sets of BER and power level measurement values:
processing the multiple sets of BER and power level measurement values to determine an actual BER; and
evaluating the sensitivity of the receiver based on the actual BER.

17. The method of claim 16, wherein the electrical test signal corresponds to a bit pattern, and wherein the method further comprises:
in the transceiver, generating the bit pattern with a bit pattern generator; and
providing a waveform corresponding to the generated bit pattern to a laser driver that modulates the laser with the test signal.

18. The method of claim 17, wherein the electrical test signal corresponds to a bit pattern, and wherein the method further comprises:
in the transceiver, generating the bit pattern with a bit pattern generator; and
providing a waveform corresponding to the generated bit pattern to an eye shaper comprising waveform shaping circuitry;
in the waveform shaping circuitry of the eye shaper, shaping the waveform to produce a stressed waveform, the stressed waveform corresponding to the electrical test signal used to modulate the laser to produce the optical test signal.

19. The method of claim 15, further comprising:
in sampling circuitry of the receiver portion of the transceiver, sampling the received electrical test signal to obtain sample data;
in processing circuitry of the transceiver, processing the sample data to generate an eye diagram; and
in eye monitor circuitry of the transceiver, processing the sample data to measure one or more signal quality characteristics associated with the electrical signal produced by the optical signal detector.

20. The method of claim 15, further comprising:
in sampling circuitry of the receiver portion of the transceiver, sampling the received electrical test signal to obtain sample data; and
in eye monitor circuitry of a host computer external to the transceiver, receiving the sample data and processing the sample data to measure one or more signal quality characteristics associated with the electrical signal produced by the optical signal detector.

21. The method of claim 15, wherein the optical attenuator is within the transceiver, and wherein the optical waveguides are internal to the transceiver.

22. The method of claim 15, wherein the optical attenuator is external to the transceiver, and wherein the optical waveguides are optical fibers that are external to the transceiver, each optical fiber having an end that is optically coupled to the transceiver.

23. The method of claim 15, wherein the method is performed during a production phase prior to shipment of the transceiver to a customer.

24. The method of claim 15, wherein the method is performed in situ while the transceiver is operationally connected to a network.
